(19) United States
(12) Patent Application Publication
(10) Pub. No.: US 2026/0158888 A1
(43) Pub. Date: Jun. 11, 2026

(54) VEHICLE ROOF WITH MANUALLY CONFIGURABLE FOLDING PANELS

(71) Applicant: Ford Global Technologies, LLC, Dearborn, MI (US)

(72) Inventors: Michael John Harmon, Northville, MI (US); Robert J. Gelardi, Plymouth, MI (US); Daniel J. Kangas, Livonia, MI (US); Justin D. Sorum, Royal Oak, MI (US)

(21) Appl. No.: 18/973,230

(22) Filed: Dec. 9, 2024

(51) Int. Cl. B60J 7/14; B60J 7/11

(52) U.S. Cl. CPC B60J 7/146; B60J 7/11

(57) ABSTRACT

A motor vehicle may include a roof including a roof opening. The motor vehicle may also include a panel manually configurable between a closed position in which the panel covers at least a portion of the roof opening and an open position. Further, when moving between the closed and open positions, the panel may rotate substantially 180° about an axis adjacent an end of the panel.

### TECHNICAL FIELD

This disclosure relates to a motor vehicle including a roof with manually configurable folding panels.

### BACKGROUND

Motor vehicles, including sport utility vehicles (SUVs), are known to include roofs that incorporate roof openings. These roof openings are configured be selectively uncovered, enabling passengers to enjoy the air and natural elements while maintaining the option for full coverage when needed.

### SUMMARY

In some aspects, the techniques described herein relate to a motor vehicle, including: a roof including a roof opening; and a panel manually configurable between a closed position in which the panel covers at least a portion of the roof opening and an open position, wherein, when moving between the closed and open positions, the panel rotates substantially 180° about an axis adjacent an end of the panel.

In some aspects, the techniques described herein relate to a motor vehicle, wherein: the panel is a first panel, the motor vehicle further includes a second panel, and when the first panel is in the open position, the first panel substantially vertically overlaps the second panel.

In some aspects, the techniques described herein relate to a motor vehicle, wherein, when the first panel is in the open position, the first and second panels are removable, as a unit, from the motor vehicle.

In some aspects, the techniques described herein relate to a motor vehicle, wherein the second panel is not rotatable relative to the first panel.

In some aspects, the techniques described herein relate to a motor vehicle, wherein: the second panel is manually configurable between a closed position in which the second panel covers at least a portion of the roof opening and an open position, when moving between the closed and open positions, the second panel rotates substantially 180° about an axis arranged adjacent an end of the second panel proximate the first panel.

In some aspects, the techniques described herein relate to a motor vehicle, wherein: the first panel is moveable between the closed and open positions when the second panel is in the closed position, and the second panel is moveable between the closed and open positions when the first panel is in the closed position.

In some aspects, the techniques described herein relate to a motor vehicle, wherein the first and second panels are substantially identically sized and shaped.

In some aspects, the techniques described herein relate to a motor vehicle, wherein: the first panel includes a bumper on an upper surface thereof, the second panel includes a bumper on an upper surface thereof, wherein, when the first panel is in the open position, the bumpers of the first and second panels are configured to contact one another.

In some aspects, the techniques described herein relate to a motor vehicle, wherein: the panel is configured to rotate about an axis substantially perpendicular to a centerline of the motor vehicle, and the axis is between a first end and a second end of the roof opening.

In some aspects, the techniques described herein relate to a motor vehicle, wherein the axis is substantially halfway between the first end and the second end of the roof opening.

In some aspects, the techniques described herein relate to a motor vehicle, further including a hinge assembly configured to permit the first panel to rotate relative to the second panel about the axis.

In some aspects, the techniques described herein relate to a motor vehicle, wherein the hinge assembly is a soft-close hinge assembly.

In some aspects, the techniques described herein relate to a motor vehicle, wherein: the panel includes at least one lever rotatable between a first position and a second position, when the panel is in the closed position and the lever is in the first position, the lever is configured to prevent movement of the panel relative to the roof, and when the panel is in the closed position and the lever is in the second position, the lever is configured to not interfere with movement of the panel relative to the roof.

In some aspects, the techniques described herein relate to a motor vehicle, wherein: the roof opening includes a first end and a second end, and when the panel is in the open position, the lever is configured to interface with an attachment point adjacent the second end of the roof opening.

In some aspects, the techniques described herein relate to a motor vehicle, wherein: the panel is a first panel and the motor vehicle further includes a second panel, the second panel is manually configurable between a closed position in which the second panel covers at least a portion of the roof opening and an open position, when moving between the closed and open positions, the second panel rotates substantially 180° about an axis arranged adjacent an end of the second panel proximate the first panel, the attachment point is a first attachment point and the motor vehicle further includes a second attachment point adjacent the first end of the roof opening, the lever is a first lever, the second panel includes a second lever, and when the second panel is in the open position, the second lever is configured to interface with the second attachment point.

In some aspects, the techniques described herein relate to a motor vehicle, wherein: the first attachment point establishes at least part of a closed loop projecting upward from a location adjacent the second end of the roof opening, and the second attachment point establishes at least part of a closed loop projecting upward from a location adjacent the first end of the roof opening.

In some aspects, the techniques described herein relate to a motor vehicle, wherein a majority of the panel by surface area is transparent.

In some aspects, the techniques described herein relate to a motor vehicle, wherein the panel includes a handle adjacent an end thereof configured such that a user may grasp the handle to facilitate movement of the panel between the closed and open positions.

In some aspects, the techniques described herein relate to a method, including: manually moving a panel from a closed position, in which the panel covers at least a portion of a roof opening of a motor vehicle, to an open position by rotating the panel substantially 180° about an axis arranged adjacent an end of the panel.

In some aspects, the techniques described herein relate to a method, wherein the panel is a first panel, and further including: manually moving a second panel from a closed position, in which the second panel covers at least a portion of the roof opening, to an open position, wherein, when moving between the closed and open positions, the second panel rotates substantially 180° about an axis arranged adjacent an end of the second panel proximate the first panel.

### BRIEF DESCRIPTION OF THE DRAWINGS

FIG. 1 illustrates a front perspective view of an example motor vehicle, which in this example is an SUV.

FIG. 2 is a top perspective view of a roof of the motor vehicle, with panels arranged such that a roof opening is fully covered.

FIG. 3 is a view similar to FIG. 2, with a panel in an open position.

FIG. 4 is a view similar to FIG. 2, representing removal of the panels, as a unit, from the vehicle.

FIG. 5 is a close-up view of a portion of a hinge assembly.

FIG. 6 is a view, from an interior of the motor vehicle, of the panels configured substantially as in FIG. 2.

FIG. 7 illustrates an example lever.

FIG. 8 illustrates another embodiment of this disclosure, in which a second panel is moveable relative to a first panel.

FIG. 9 is a view similar to FIG. 8 with the second panel in an open position.

### DETAILED DESCRIPTION

This disclosure relates to a motor vehicle including a roof with manually configurable folding panels. Among other benefits, this disclosure allows a user to arrange the roof in a custom configuration to expose a desired portion of the passenger compartment to the elements. Further, the roof is configurable by hand, without the use of electrically powered equipment or tools.

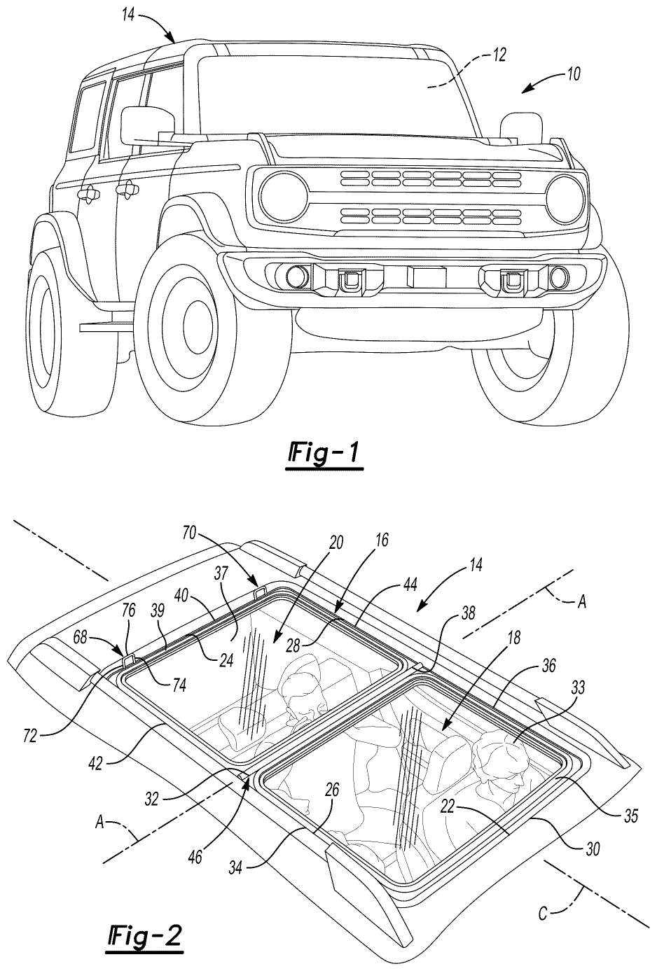

FIG. 1 illustrates a motor vehicle 10 (“vehicle 10”), which in this example is a sport utility vehicle (SUV). While an SUV is shown, the vehicle 10 could be another type of vehicle.

The vehicle 10 includes a passenger compartment, or passenger cabin, 12. A roof 14 is vertically above the passenger compartment 12. The roof 14 is defined by a body and/or a frame of the vehicle 10, and is generally configured to cover the passenger compartment 12 to protect the occupants from the weather and other elements.

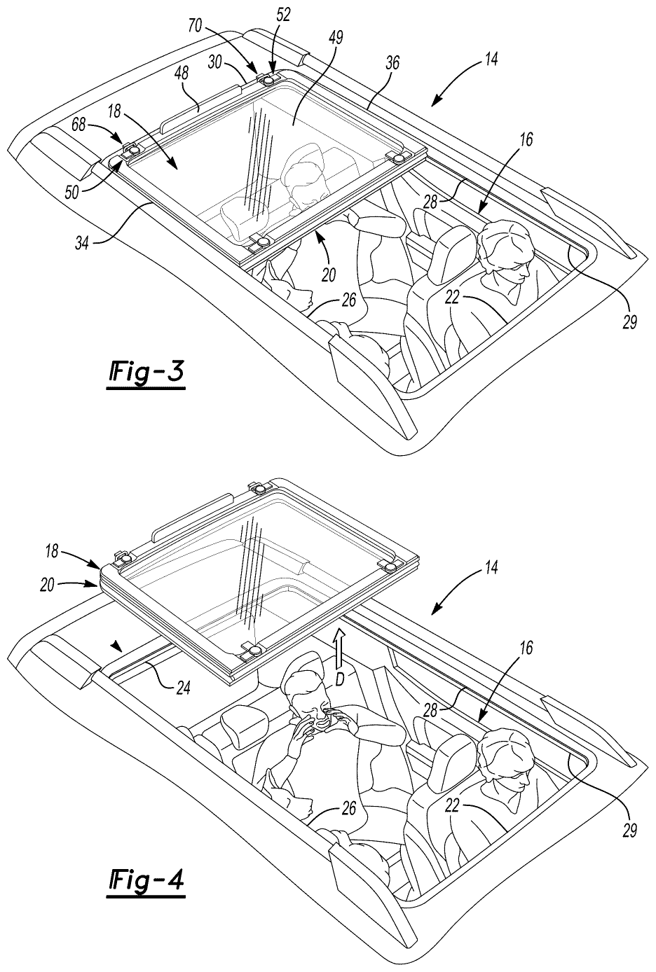

With reference to FIG. 2, the roof 14 includes a roof opening 16. The roof opening 16 is fully covered by first and second panels 18, 20, in FIG. 2. At least one of the panels 18, 20 is manually configurable to an open position in which the panel(s) 18, 20 do(es) not cover at least a portion of the roof opening 16. In FIG. 2, the panels 18, 20 are arranged such that the roof opening 16 is in a fully covered configuration. In FIG. 3, the panel 18 is an open position, and a forward portion of the roof opening 16 is uncovered by the panel 18. In FIG. 4, the panels 18, 20 have been removed, as a unit, from the roof 14 such that the roof opening 16 is fully uncovered.

With reference to FIG. 2, the roof opening 16 is defined between a first end 22, a second end 24 opposite the first end 22, a first side 26 extending between the first and second ends 22, 24, and a second side 28 opposite the first side 26 and extending between the first and second ends 22, 24. The roof opening 16 is substantially rectangular in this example. The roof opening 16 exhibits an area within a range of 65-85% of the area of the roof 14 (inclusive of the roof opening 16). An elastomeric seal 29 (FIGS. 3 and 4) may extend about the entire perimeter of the roof opening 16. When the panels 18, 20 are configured as in FIG. 2, the panels 18, 20 may be held in contact with the elastomeric seal 29 to resist ingress of water, dirt, etc., relative to the passenger compartment 12.

With reference to the configuration of FIG. 2, the first panel 18 is arranged forward of the second panel 20. The “forward” direction is used herein with reference to a normal orientation of a motor vehicle. The first panel 18 includes a first end 30, a second end 32 opposite the first end 30, a first side 34 extending between the first and second ends 30, 32, and a second side 36 opposite the first side 34 and extending between the first and second ends 30, 32. In this example, a majority of a surface area of the panel 18 is transparent. In particular, a majority of the surface area of the panel 18 is provided by glass. Further, an upper surface 33 of the first panel 18 includes a bumper 35. The bumper 35 is arranged substantially close to an edge of the panel 18 and extends about substantially the entire perimeter of the panel 18.

The second panel 20 includes a first end 38, a second end 40 opposite the first end 38, a first side 42 extending between the first and second ends 38, 40, and a second side 44 opposite the first side 42 and extending between the first and second ends 38, 40. In this example, a majority of a surface area of the panel 20 is transparent. In particular, a majority of the surface area of the panel 20 is provided by glass.

An upper surface 37 of the second panel 20 includes a bumper 39. The bumper 39 is arranged substantially close to an edge of the panel 20 and extends about substantially the entire perimeter of the panel 20. Bumpers 35, 39 are configured to contact one another when one of the panels 18, 20 is in an open position. Bumpers 35, 39 may be made of elastomeric material, such as rubber, and are configured to provide padding between panels 18, 20. The term “upper,” as in upper surfaces 33, 37, is used with reference to the orientation of the panels 18, 20 in FIG. 2.

The first and second panels 18, 20 are substantially similarly-sized in this example. In particular, when the first and second panels 18, 20 are in the configuration of FIG. 2, the first panel 18 covers substantially 50% of the area of the roof opening 16, and the second panel covers substantially 50% of the area of the roof opening 16. In a specific example, the first and second panels 18, 20 are substantially identically sized and shaped.

In this disclosure, at least one panel is manually configurable between a closed position (i.e., a fully closed position) and an open position. When in the open position, at least a portion of the roof opening 16 is uncovered by the panel.

In an specific aspect of this disclosure, panel 18 is manually configurable between a closed position, as shown in FIG. 2, in which the panel 18 covers at least a portion of the roof opening 16 and an open position, as shown in FIG. 3. The panel 18 is configured to be manually folded when moving between the closed and open positions. Specifically, when moving between the closed and open positions, the panel 18 rotates substantially 180° about an axis A.

Axis A is between the first end 22 and the second end 24 of the roof opening 16. In particular, the axis A is substantially halfway between the first end 22 and the second end 24 of the roof opening 16. Axis A is proximate end 32 and end 38. Axis A is substantially perpendicular to a centerline C of the vehicle 10, in this example. The axis A could be parallel to the centerline C in another example, and in that example the panels 18, 20 could be manually configurable to open and close a corresponding side of the roof opening 16.

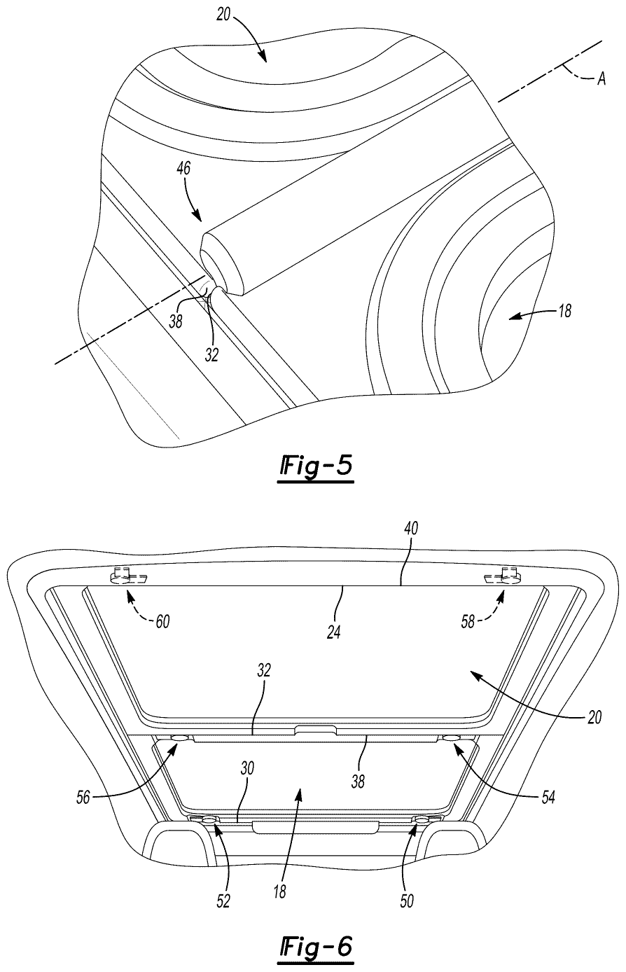

With reference to FIG. 5, a hinge assembly 46 is configured to permit the panel 18 to rotate about axis A by substantially 180° between the closed position of FIG. 2 and the open position of FIG. 3. Because of the arrangement of the hinge assembly 46, this disclosure may be said to disclose a center-folding panel arrangement. The hinge assembly 46 is configured to couple to the panel 18, at a location adjacent end 32, and to panel 20, at a location adjacent end 38. The hinge assembly 46 may include a pair of interlocking components configured to facilitate the rotational movements described herein. The hinge assembly 46 may include a central pin extending along axis A, and each panel 18, 20 may be rotatably coupled to that central pin.

The hinge assembly 46 may be a soft-close hinge assembly, meaning the hinge assembly 46 is configured to slow down movement of the panel 18, for example, to gently complete the movement of the panel 18 to the open position or the closed position, without the panel 18 slamming relative to panel 20 or the roof 14.

Adjacent end 30, panel 18 may include a handle 48 (FIG. 3) configured such that a user may grasp the handle 48 to facilitate movement of the panel 18 between the closed and open positions. Handle 48 is substantially halfway between sides 34, 36. The handle 48 projects downward from a lower surface 49 of the panel 18. The term “lower surface” refers to the lower surface of the panel 18, when the panel 18 is oriented as in FIG. 2.

The panels 18, 20 each include one or more levers configured to hold the panels 18, 20 relative to one another, the roof 14, and/or one or more attachment points. With reference to FIG. 6, panel 18 includes a first lever 50 and a second lever 52 adjacent end 30. Panel 18 further includes a third lever 54 and a fourth lever 56 adjacent end 32. The panel 20 includes levers 58, 60 (shown in phantom) adjacent end 40. Levers 50, 52 are manually rotatable, by a user by hand and without tools, to selectively engage the panel 18 with a portion of the roof 14 adjacent end 22. Levers 54, 56 are manually rotatable to selectively engage the panel 18 with the panel 20. Further, levers 58, 60 are manually rotatable to selectively engage the panel 20 with a portion of the roof 14 adjacent end 24. While a particular number and configuration of levers has been shown and described, this disclosure extends to vehicles with a different quantity and configuration of levers.

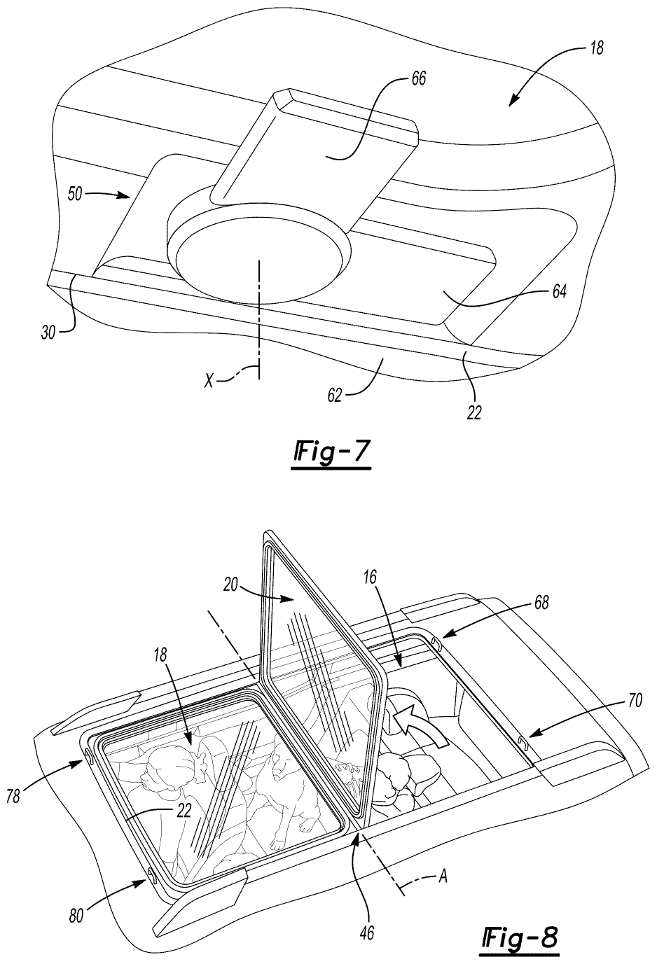

The lever 50 is shown in detail in FIG. 7. Lever 50 is representative of the arrangement of the other levers 52, 54, 56, 58, 60. Lever 50 is disengaged with a portion 62 of the roof 14 adjacent end 22 in this example. Specifically, lever 50 includes a first arm 64 and a second arm 66. The first arm 64 may include a cam surface configured to engage a corresponding surface of portion 62. The second arm 66 is configured as a handle and is able to be grasped by a user. A user can grasp second arm 66 to rotate the lever 50 about axis X, such that the first arm 64 comes selectively into and out of engagement with portion 62. In the configuration of FIG. 7, the lever 50 is configured so as to not prevent movement of panel 18 relative to the roof 14 or the second panel 20. When the lever 50 is rotated such that the first arm 64 contacts the portion 62, such as when the lever 50 is rotated substantially 90° about axis X relative to configuration in FIG. 7, the lever 50 is configured to prevent movement of the panel 18 relative to the roof 14 and the second panel 20.

The vehicle 10 includes at least one attachment point configured to interface with at least one of the levers 50, 52 to hold the first panel 18 in the open position relative to the second panel 20, in this example. For example, with reference to FIG. 2, adjacent second end 24, the vehicle 10 includes a first attachment point 68 and a second attachment point 70.

Each attachment point 68, 70 establishes at least part of a closed loop. In this example, the attachment points 68, 70 project upward from the second panel 20 adjacent end 40. Attachment points 68, 70 could project upward from a portion of the roof 14 in other examples. With reference to attachment point 68, attachment point 68 includes first and legs 72, 74 projecting substantially parallel to one another and in an upward direction from the upper surface 37 of the second panel 20. The attachment point 68 further includes a third leg 76 extending between the legs 72, 76 in a direction substantially perpendicular thereto. Together, upper surface 37 and legs 72, 74, 76 form a closed loop. Attachment point 70 is configured substantially similar to attachment point 68.

When panel 18 is in the open position, as shown in FIG. 3, lever 50 is rotatable such that first arm 64 projects into the closed loop defined by attachment point 68. Lever 52 is likewise rotatable such that its corresponding first arm projects into a closed loop defined by attachment point 70. In this way, the panel 18 may be held in place relative to panel 20. Panel 18 is not rotatable back to the closed position until the levers 50, 52 are rotated out of engagement with a corresponding one of the attachment points 68, 70.

In the orientation of FIG. 3, with the first panel 18 in the open position, the first panel 18 substantially vertically overlaps the second panel 20. In particular, the surface area of the first panel 18 substantially covers the entire surface area of the second panel 20, and the panels 18, 20 are substantially aligned in the forward-rearward and cross-car directions.

When the first panel 18 is in the open position of FIG. 3, the levers 58, 60 may be rotated out of engagement with the roof 14 such that the first and second panels 18, 20 may be removed from the roof 14 as a unit, or module, as shown in FIG. 4. A user is able to remove the first and second panels 18, 20, which are held together via levers 50, 52 and attachment points 68, 70, by lifting the first and second panels 18, 20, as a unit, in a vertically upward direction D. The user may then insert the first and second panels 18, 20 into a bag for storage.

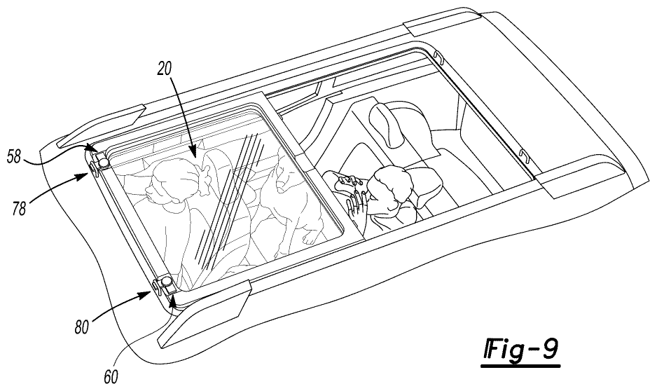

In the embodiment of FIGS. 2-7, the second panel 20 is not configured for rotation relative to the first panel 18. However, in another embodiment, shown in FIGS. 8 and 9, the first panel 18 is configured to rotate between a closed and open position, and the panel 20 is also configured to rotate between a closed and open position.

In particular, in the embodiment of FIGS. 8 and 9, the hinge assembly 46 is configured to permit rotation of both panels 18, 20 about axis A. Specifically, the hinge assembly 46 is configured to permit the same movement of the first panel 18 as in the previous embodiment, and is further configured such that, when moving between the closed and open positions, the second panel 20 is configured to rotate substantially 180° about axis A.

In the embodiment of FIGS. 8 and 9, the first panel 18 is moveable between the closed and open positions when the second panel 20 is in the closed position, and the second panel 20 is moveable between the closed and open positions when the first panel 18 is in the closed position. In other words, the first and second panels 18, 20 are not configured for simultaneous movement.

The vehicle 10 includes third and fourth attachment points 78, 80 adjacent the first end 22 of the roof opening 16. Attachment points 78, 80 are configured substantially similar to attachment points 68, 70. As shown in FIG. 9, when the second panel 20 is in the open position, in which the second panel 20 substantially vertically overlaps the first panel 18, lever 58 is rotatable such its corresponding first arm projects into a closed loop defined by attachment point 78. Lever 60 is likewise rotatable such that its corresponding first arm projects into a closed loop defined by attachment point 80. In this way, the panel 20 may be held in place relative to panel 18.

In the configuration of FIG. 3, a front portion of roof opening 16 is uncovered, while in FIG. 9, a rear portion of the roof opening 16 is uncovered. In both configurations, the panels 18, 20 are able to be held in place relative to the roof 14, which permits users to expose a desired portion of the roof opening 16 conveniently and without the need to fully remove panels 18, 20 from vehicle 10.

Because of the relatively low profile of the panels 18, 20, the panels 18, 20 can remain on the vehicle 10 in the position of FIG. 2, FIG. 3, or FIG. 9, without interfering with a roof rack, which may include cross-bars supporting gear over the roof opening 16.

Reference to the panels 18, 20 being manually configurable means the panels 18, 20 are able to be configured between the fully closed and various open positions without powered electrical components, such as motors, drives, actuators, etc., and further refers to the panels 18, 20 being configurable by a user by hand and without the use of tools such as screwdrivers, drills, wrenches, etc.

It should be understood that terms such as “about,” “substantially,” and “generally” are not intended to be boundaryless terms, and should be interpreted consistent with the way one skilled in the art would interpret those terms. Further, directional terms such as “upper,” “forward,” “rearward,” “upward,” “downward,” “vertical,” “horizontal,” “below,” “top,” “bottom,” etc., are used for purposes of explanation only and should not otherwise be construed as limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A motor vehicle, comprising:
a roof including a roof opening; and
a panel manually configurable between a closed position in which the panel covers at least a portion of the roof opening and an open position, wherein, when moving between the closed and open positions, the panel rotates substantially 180° about an axis adjacent an end of the panel.

2. The motor vehicle as recited in claim 1, wherein:
the panel is a first panel,
the motor vehicle further includes a second panel, and
when the first panel is in the open position, the first panel substantially vertically overlaps the second panel.

3. The motor vehicle as recited in claim 2, wherein, when the first panel is in the open position, the first and second panels are removable, as a unit, from the motor vehicle.

4. The motor vehicle as recited in claim 2, wherein the second panel is not rotatable relative to the first panel.

5. The motor vehicle as recited in claim 2, wherein:
the second panel is manually configurable between a closed position in which the second panel covers at least a portion of the roof opening and an open position,
when moving between the closed and open positions, the second panel rotates substantially 180° about an axis arranged adjacent an end of the second panel proximate the first panel.

6. The motor vehicle as recited in claim 5, wherein:
the first panel is moveable between the closed and open positions when the second panel is in the closed position, and
the second panel is moveable between the closed and open positions when the first panel is in the closed position.

7. The motor vehicle as recited in claim 2, wherein the first and second panels are substantially identically sized and shaped.

8. The motor vehicle as recited in claim 2, wherein:
the first panel includes a bumper on an upper surface thereof,
the second panel includes a bumper on an upper surface thereof,
wherein, when the first panel is in the open position, the bumpers of the first and second panels are configured to contact one another.

9. The motor vehicle as recited in claim 1, wherein:
the panel is configured to rotate about an axis substantially perpendicular to a centerline of the motor vehicle, and
the axis is between a first end and a second end of the roof opening.

10. The motor vehicle as recited in claim 9, wherein the axis is substantially halfway between the first end and the second end of the roof opening.

11. The motor vehicle as recited in claim 9, further comprising a hinge assembly configured to permit the first panel to rotate relative to the second panel about the axis.

12. The motor vehicle as recited in claim 11, wherein the hinge assembly is a soft-close hinge assembly.

13. The motor vehicle as recited in claim 1, wherein:
the panel includes at least one lever rotatable between a first position and a second position,
when the panel is in the closed position and the lever is in the first position, the lever is configured to prevent movement of the panel relative to the roof, and
when the panel is in the closed position and the lever is in the second position, the lever is configured to not interfere with movement of the panel relative to the roof.

14. The motor vehicle as recited in claim 13, wherein:
the roof opening includes a first end and a second end, and
when the panel is in the open position, the lever is configured to interface with an attachment point adjacent the second end of the roof opening.

15. The motor vehicle as recited in claim 14, wherein:
the panel is a first panel and the motor vehicle further comprises a second panel,
the second panel is manually configurable between a closed position in which the second panel covers at least a portion of the roof opening and an open position,
when moving between the closed and open positions, the second panel rotates substantially 180° about an axis arranged adjacent an end of the second panel proximate the first panel,
the attachment point is a first attachment point and the motor vehicle further comprises a second attachment point adjacent the first end of the roof opening,
the lever is a first lever,
the second panel includes a second lever, and
when the second panel is in the open position, the second lever is configured to interface with the second attachment point.

16. The motor vehicle as recited in claim 15, wherein:
the first attachment point establishes at least part of a closed loop projecting upward from a location adjacent the second end of the roof opening, and
the second attachment point establishes at least part of a closed loop projecting upward from a location adjacent the first end of the roof opening.

17. The motor vehicle as recited in claim 1, wherein a majority of the panel by surface area is transparent.

18. The motor vehicle as recited in claim 1, wherein the panel includes a handle adjacent an end thereof configured such that a user may grasp the handle to facilitate movement of the panel between the closed and open positions.

19. A method, comprising:
manually moving a panel from a closed position, in which the panel covers at least a portion of a roof opening of a motor vehicle, to an open position by rotating the panel substantially 180° about an axis arranged adjacent an end of the panel.

20. The method as recited in claim 19, wherein the panel is a first panel, and further comprising:
manually moving a second panel from a closed position, in which the second panel covers at least a portion of the roof opening, to an open position, wherein, when moving between the closed and open positions, the second panel rotates substantially 180° about an axis arranged adjacent an end of the second panel proximate the first panel.
